(19) United States
(12) Patent Application Publication
(10) Pub. No.: US 2025/0145412 A1
(43) Pub. Date: May 8, 2025

(54) ELEVATOR SAFETY SYSTEM

(71) Applicant: Otis Elevator Company, Farmington, CT (US)

(72) Inventors: Gérard Sirigu, Gien (FR); Alper Caliskan, Gien (FR); Aurélien Fauconnet, Isdes (FR)

(21) Appl. No.: 18/933,328

(22) Filed: Oct. 31, 2024

(30) Foreign Application Priority Data
Nov. 2, 2023 (EP) 23306898.0

(51) Int. Cl. B66B 5/00

(52) U.S. Cl. CPC B66B 5/0062; B66B 5/0081; B66B 2201/46

(57) ABSTRACT

A safety system (105) for an elevator system (100). The safety system (105) includes a plurality of sensors (120) and a controller (110). Each of the plurality of sensors (120) is configured to produce an override signal when a landing door (112a) to which the sensor is connected is opened by manual override. The controller (110) is configured to instruct the elevator system (100) to automatically enter a special operating mode when the override signal is received from one of the plurality of sensors (120).

### FOREIGN PRIORITY

This application claims priority to European Patent Application No. 23306898.0, filed Nov. 2, 2023, and all the benefits accruing therefrom under 35 U.S.C. § 119, the contents of which in its entirety are herein incorporated by reference.

### TECHNICAL FIELD OF INVENTION

The present disclosure relates to systems and methods for ensuring the safety of service personnel while accessing an elevator hoistway.

### BACKGROUND OF THE INVENTION

During elevator service procedures, service personnel are often required to enter the hoistway of an elevator system to access drive systems, lighting systems, sensor systems, call systems and various other components. To do so, service personnel gain entry to the hoistway at a landing above or below the elevator car. When service personnel are in the hoistway and not protected by being inside an elevator car, further protection must be provided.

A variety of safeguards should be provided to the service personnel when they are working in the hoistway. For example, a limit on how close the elevator car can be to the top of the hoistway must be set. Currently, the elevator system must be put into the service mode manually by the service personnel. Should the service personnel forget to perform this step, or if a non-service personnel somehow gains entry to the hoistway, serious incidents could occur.

Therefore, there exists a need for a system that automatically switches the elevator system into the service mode before service personnel gains entry to the hoistway.

### SUMMARY OF THE INVENTION

According to a first aspect of the disclosure, there is provided a safety system for an elevator system. The elevator system comprises a hoistway, a plurality of landing doors located on respective landings and an elevator car provided in the hoistway. The plurality of landing doors are configured to provide access to the hoistway. The safety system comprises a plurality of sensors and a controller. Each of the plurality of sensors is configured to produce an override signal when a landing door to which the sensor is connected is opened by a manual override. The controller is configured to instruct the elevator system to automatically enter a special operating mode when the override signal is received from one of the sensors.

It will be understood that the controller automatically instructs the elevator system to enter a special operating mode as an additional safety measure. By making this process automatic, it reduces the likelihood of injury occurring to service personnel when performing service procedures such as inspections or maintenance on elevator systems.

It will also be appreciated that the safety system may operate independently of other controls within the elevator system such that it can be provided as a standalone system. As such, the safety system may be retrofitted into existing elevator systems and buildings, providing a cost effective and environmentally friendly way of improving the safety of service personnel.

It will be further appreciated that there is no requirement for the safety system to monitor or detect the position of the elevator car in the hoistway in order to instruct the elevator system to automatically enter a special operating mode. Thus, the system according to the disclosure is straightforward and cost effective to implement even in very basic existing elevator systems.

In some examples, the plurality of sensors are connected to the controller by a wireless connection.

In some examples, the plurality of sensors are connected to the controller by a wired connection.

The plurality of sensors could be connected to the controller in any conceivable way such that they can communicate with the controller. In different applications, different connection methods may be applied.

In some examples, the plurality of sensors do not produce the override signal when the landing door to which each sensor is connected is opened in response to an elevator car arriving at the landing door.

In some examples, the plurality of sensors are configured such that no override signal is produced when a landing door is opened in response to the elevator car arriving at that landing.

In some examples, each of the plurality of sensors is configured to be connected to a landing door of a respective landing.

In some examples, the plurality of sensors are connected in series.

By connecting the sensors in series, the complexity of the system is reduced. However, other connection methods are available that may be used to provide further detail on which sensor is producing the override signal.

In some examples, each of the plurality of sensors comprises a switch.

In some examples, each of the plurality of sensors is configured to produce an override signal in response to being activated by a key.

In some examples, each of the plurality of sensors comprises a switch comprising an electrical contact which is opened when the landing door to which the sensor is connected is opened by a manual override.

In some examples, the special operating mode is a service mode.

In some examples, one or more of the plurality of sensors is configured to produce an override signal in response to being activated by a key, optionally wherein the key is configured to allow a landing door to be opened by a manual override when inserted into a lock.

According to a further aspect of the disclosure, there is provided an elevator system. The elevator system comprises a hoistway; an elevator car disposed in the hoistway; a plurality of landing doors each located at respective landings and configured to provide access to the hoistway, the elevator car being adapted to travel to the respective landings. The elevator system further comprises the safety system for an elevator system as described above. Each of the one or more sensors is connected to a respective one of the landing doors.

In some examples, when in the special operating mode, the elevator system is configured to deploy a safety brake and/or a safety barrier, optionally an upper balustrade on the elevator car.

In some examples, when in the special operating mode, the elevator car is unable to move.

According to a yet further aspect of the disclosure, there is provided a method of operating a safety system for an elevator system. The elevator system comprises: a hoistway, a plurality of landing doors located on respective landings, and an elevator car provided in the hoistway. The plurality of landing doors are configured to provide access to the hoistway. The safety system comprises a plurality of sensors each connected to a respective landing door and a controller. The method comprises opening a landing door by manual override; in response to the opening the landing door by manual override, the sensor connected to the landing door producing an override signal; and in response to the controller receiving the override signal, the controller instructing the elevator system to automatically enter a special operating mode.

In some examples, the method comprises the elevator system deploying a safety brake and/or a safety barrier, optionally an upper balustrade on the elevator car, on entering the special operating mode.

According to a yet further aspect of the disclosure, there is provided a computer program product for a controller of a safety system as described above, or an elevator system as described above. The computer program product includes instructions that, when executed by a processor, cause the controller to perform operations comprising: in response to receiving the override signal from one of the plurality of sensors, instructing the elevator system to automatically enter a special operating mode.

According to a yet further aspect of the disclosure, there is provided a method of modifying an elevator system. The elevator system comprises: a hoistway, a plurality of landing doors located on respective landings, and an elevator car provided in the hoistway. The plurality of landing doors are configured to provide access to the hoistway. The method comprises: connecting a respective sensor to each of the plurality of landing doors, each sensor being configured to produce an override signal in response to the landing door to which it is connected being opened by a manual override; and connecting the sensors to a controller, the controller being configured to cause the elevator system to automatically enter a special operating mode in response to receiving the override signal from the one of the sensors.

### BRIEF DESCRIPTION OF THE DRAWINGS

FIG. 1 shows a schematic illustration of an elevator system according to at least one example of the disclosure;

FIG. 2 shows a schematic illustration of part of the elevator system of FIG. 1;

FIG. 3 shows a diagram of a method according to at least one example of the disclosure; and

FIG. 4 shows a diagram of a second method according to at least one example of the disclosure.

### DETAILED DESCRIPTION OF THE INVENTION

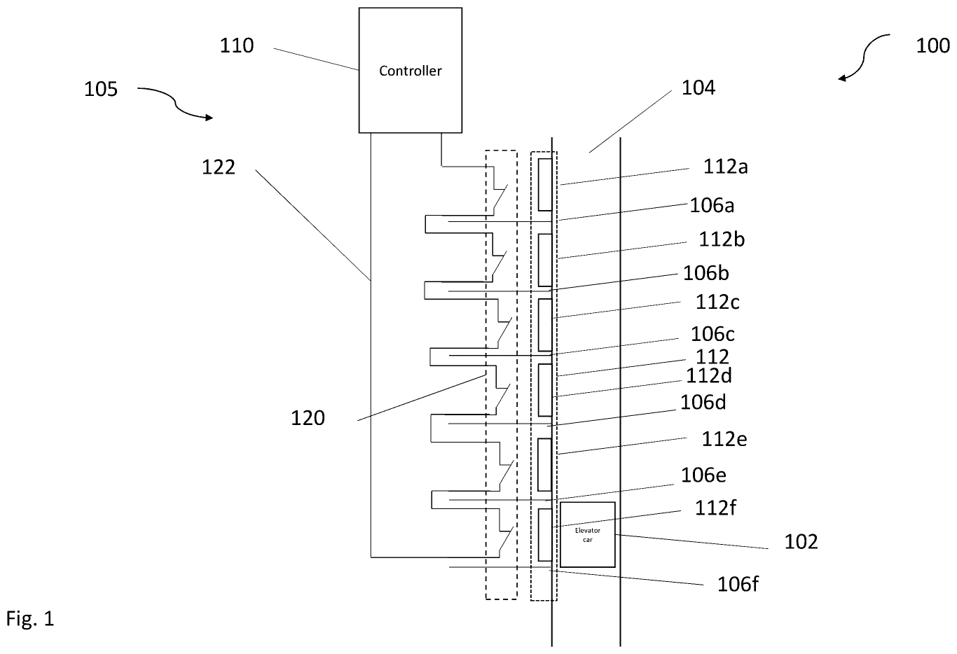

FIG. 1 shows an elevator system 100 comprising an elevator car 102 in a hoistway 104. The elevator car 102 is configured to move up and down the hoistway 104 to transport passengers between the different landings 106a-106f in a building (not shown). It will be understood that a building typically includes a number of different floors and that each floor may have a landing from which the hoistway may be accessed. Although not shown in the drawings, it will be appreciated that the elevator system 100 may comprise other standard components including but not limited to drive means, tension members, a counterweight, a power source and a control panel.

As seen in FIG. 1, the elevator system 100 comprises a plurality of landing doors 112. Each landing door 112a, 112b, 112c, 112d, 112e, 112f in the elevator system 100 is located on a different respective landing 106a-106f. The plurality of landing doors 112a-112f provide access to the hoistway 104 when open. When a landing door 112 on a landing is closed, no access to the hoistway 104 is possible from that respective landing. It will be understood that the elevator car 102 is also accessible via a landing door 112f when the elevator car 102 is located at that respective landing 106f and when both an elevator car door (not shown) and the landing door 112f are open.

The elevator system 100 comprises a safety system 105. The safety system 105 is used to ensure the safety of service personnel when attempting to enter the hoistway 104 to perform services procedures such as maintenance or inspection on the elevator car 102 or hoistway 104.

It will be understood that service personnel are personnel charged with carrying out service actions on an elevator system. They are distinct from non-service personnel only in that they perform actions on an elevator system beyond what would be considered “normal use”. The actions which may be performed by service personnel include, but are not limited to, inspection and/or maintenance of the elevator system.

The safety system 105 comprises a controller 110 (e.g., a processor-based controller executing a computer program to perform the operations described herein). The controller 110 may comprise a processor and a memory. The elevator system 100 may comprise other controllers, each performing different functions to facilitate the operation of the elevator system 100. In some examples, the controller 110 may be integrated with or be a part of the other controllers of the elevator system 100.

The safety system 105 comprises two or more sensors 120. The sensors 120 can produce an output (referred to as an override signal) in response to an event occurring. In any example of the disclosure, the event indicates that a landing door to which the sensor is connected has been opened by a manual override. The two or more sensors 120 and the controller 110 can be connected to form a safety chain 122. An output from two or more of the sensors 120 can be transmitted to the controller 110 via the safety chain 122. When the two of the sensors 120 produces the override signal, it is transmitted to the controller 110 via the safety chain 122.

In some examples, the sensors 120 are connected to each other. In such examples, the sensors 120 may be connected via a wired electrical connection. In such examples, the sensors 120 may be connected in series.

In other examples, the sensors 120 are individually connected to the controller 110. In such examples, the controller 110 may be able to discern which of the sensors 120 has produced the override signal.

In some examples, the sensors 120 are connected to the controller 110 via a wired electrical connection. In other examples, the sensors 120 are connected to the controller 110 via a wireless connection.

The override signal in some examples comprises a change in the normal output from the sensors 120 to the controller 110 via the safety chain 122.

In examples, the normal output from the sensors 120 may be a positive signal. In examples, the positive signal may be the flow of electric current. In other examples, the positive signal may be a constant stream of data sent wirelessly. In such examples, the override signal may comprise the electric current no longer flowing, or the constant stream of data sent wirelessly being interrupted.

In other examples, the normal output from the sensors 120 may be a negative signal. In examples, the negative signal may be lack of flow of electric current, or the lack of data sent wirelessly. In such examples, the override signal may comprise the flow of electric current a stream of data being sent wirelessly.

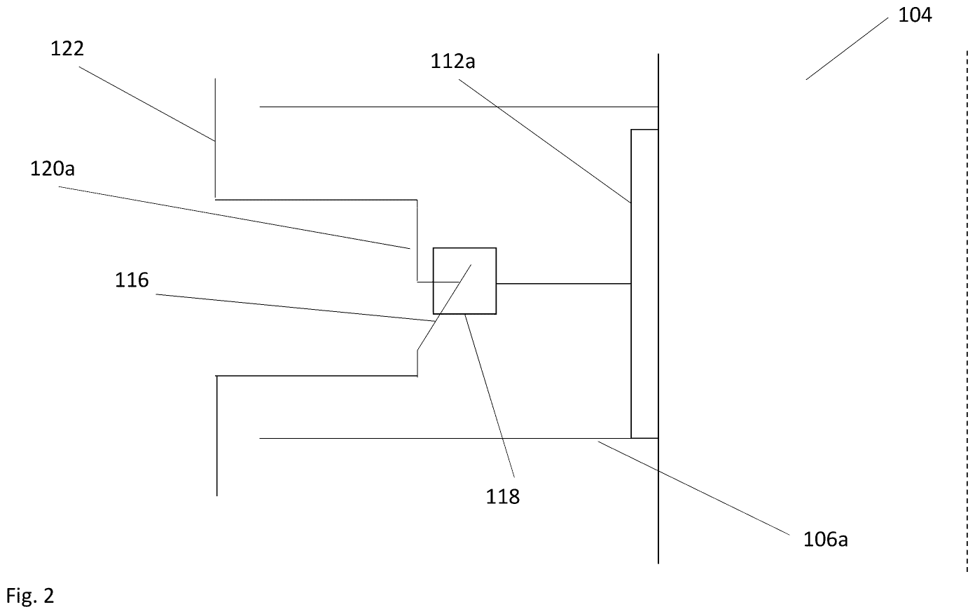

FIG. 2 is a schematic illustration of a part of the elevator system 100 seen in FIG. 1. With reference to FIG. 2, the sensors 120 are connected to the plurality of landing doors 112. In some examples, each sensor 120a is connected to a single landing door 112a. In some examples, the sensors 120 may be respectively situated adjacent to the plurality of landing doors 112 such that each landing door 112a is adjacent to a sensor 120a.

The sensors 120 are configured to produce the override signal to be received by the controller 110 when any of the plurality of landing doors 112 to which they are connected are opened by service personnel or when they are opened by a manual override. In examples, the landing door 112a may be opened by service personnel in order to gain access to the hoistway 104 and/or to the exterior of the elevator car 102 for service procedures such as maintenance and/or inspection when the elevator car 102 is situated at one of the other landing doors in the plurality of landing doors 112, or when the elevator car 102 is not situated at any of the plurality of landing doors 112.

The sensors 120 are configured to not produce the override signal in response to any of the plurality of landing doors 112 being opened in what is considered to be a “conventional” way. In this context, the “conventional” way is considered to be the landing doors 120 opening at a similar time to the elevator car doors following the arrival of the elevator car 102 at the landing at which the landing doors 120 are located.

In some examples, the two or more sensors 120 each comprise a switch. The switch may be moved from an open to a closed position by the landing door 112a being opened by a manual override or, in other words, not in the conventional way. Alternatively, the switch may be moved from a closed to an open position by the landing door 112a being opened by a manual override or, in other words, not in the conventional way. The switch may cause the override signal to be produced in response to the landing door 112a being opened by a manual override or, in other words, not in the conventional way.

In any example, the or each switch may comprise an electrical contact 116 (e.g., a switch) which is opened or closed such that, when the contact 116 is closed, current may flow along the safety chain 122 and when the contact 116 is opened, no current may flow along the safety chain 122. The controller 110 may be configured to instruct the elevator system 100 to automatically enter a special operating mode when no current is received from the safety chain 122, for example when the electrical contact 116 of one sensor 120 has been opened indicating that a landing door has been opened by a manual override.

In some examples, service personnel may open the landing door 112a by a manual override with a key (not shown), which activates the sensor 120a and causes the sensor 120a to produce the override signal which is received by the controller 110. The key may be unusually or uniquely shaped. In some examples, the key may have a blade with a triangular cross section along its longest axis.

In some examples, the sensor 120a may produce the override signal in response to the key being inserted into a lock 118, and the key subsequently being turned relative to the lock 118. The lock 118 may comprise or be part of the sensor 120a. In any example, the lock 118 may include an electrical contact 116 of the type described above such that turning the key in the lock 118 moves the electrical contact 116 from a closed position to an open position to stop current flowing through the safety chain 122 (in other words, to produce an override signal). The lock 118 may be situated adjacent to the landing door 112a. In any example, a lock 118 may be provided for each respective landing door 112.

In some examples, the landing door 112a is configured to be opened in response to the key being inserted into the lock 118, and turned relative to the lock 118. The landing door 112a may be opened in this way irrespective of the position of the elevator car 102 in the hoistway 104.

In a normal mode, the elevator system 100 permits the elevator car 102 to move freely through the hoistway 104 depending on landing calls etc.

In examples, the controller 110 constantly monitors the safety chain 122 so as to receive the output from the sensors 120. In some examples, the controller 110 may monitor the electrical current flowing through the safety chain 122 or monitor the data wirelessly transmitted via the safety chain 122.

When the controller 110 receives the override signal, which indicates that at least one of the plurality of landing doors 112 has been opened by a manual override or by service personnel, the controller 110 instructs the elevator system 100 to automatically enter a special operating mode.

In some examples, the special operating mode may be a service mode, an inspection mode, or an override mode. In some examples, the controller 110 may immediately instruct the elevator system 100 to immediately enter the special operating mode following the receipt of the override signal from one of the sensors 120.

In some examples, when in the special operating mode, the elevator system 100 deploys additional safety mechanisms to ensure the safety of service personnel in the hoistway 104, near the plurality of landing doors 112 and in or on the elevator car 102. When in the special operating mode, the elevator system 100 may deploy a safety brake (not shown) on the elevator car 102 to prevent the elevator car 102 from moving in the hoistway 104. The safety brake may prevent the elevator car 102 from moving and may not be overridden until the elevator system 100 re-enters the normal mode. Additionally or alternatively, the elevator system 100 may deploy additional safety rails or balustrades around the elevator car 102 to prevent service personnel or objects falling into the hoistway 104. The safety rail may not be removed or moved out of position until the elevator system 100 re-enters the normal mode. Additionally or alternatively, the elevator system 100 may deploy additional lighting systems and sound systems to alert people nearby and/or to assist the service personnel in carrying out their duties.

In examples where the controller 110 can discern which of the sensors 120 has produced the override signal, the elevator system 100 may deploy further safety measures at the landing door 112 (or in the hoistway 104 adjacent said landing door 112) which is associated with the sensor in the plurality of sensors 120 which has produced the override signal. In other examples, safety measures may be deployed at all of the plurality of landing doors 112.

When in the special operating mode, the elevator system 100 is in a safe state for the hoistway 104 to be accessed and for service procedures such as maintenance or inspection to be carried out.

In examples, the controller 110 may also be configured to instruct the elevator system 100 to return to the normal mode. In some examples, the controller 110 may instruct the elevator system 100 to return to the normal mode in response to receiving a normal output from the sensors 120 which produced the override signal. In examples, the normal output may be received via the safety chain 122. In some examples, the normal output may be produced in response to the key being turned and removed from the lock 118, in some examples closing the electrical contact 116.

In other examples, the elevator system 100 may return to the normal mode following further instruction input (for example to the controller) by service personnel.

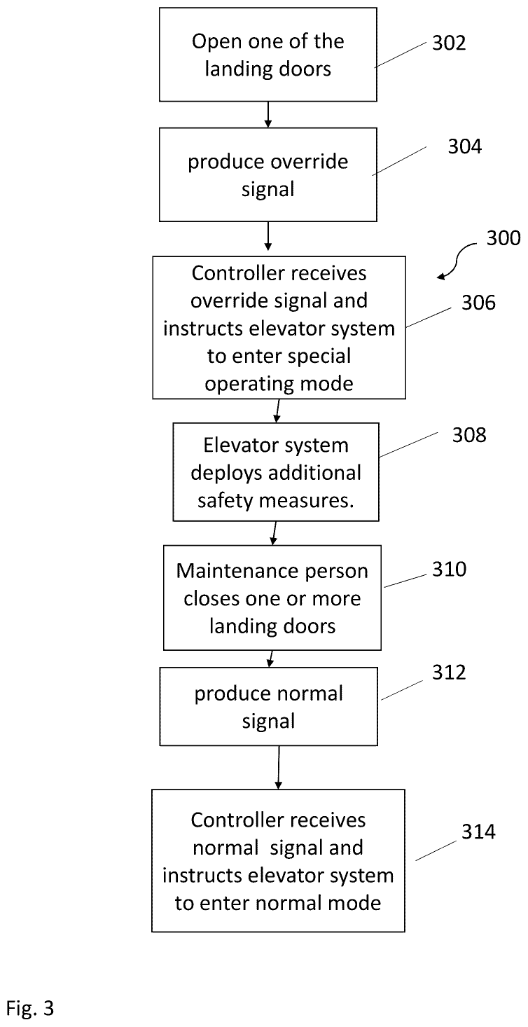

FIG. 3 depicts a method 300 of operating the safety system 105 of the elevator system 100 is also disclosed. The safety system 105 and elevator system 100 may comprise all of the features as described above.

The method 300 comprises the service personnel opening one or more of the plurality of landing doors 112 by a manual override (step 302). In some examples, the service personnel may open one of the plurality of landing doors 112 by inserting the key into the lock 118 and turning the key relative to the lock 118. In other examples, the service personnel may open one of the landing doors 112 by pressing a button, or entering a code into a number pad.

In response to the service personnel opening one of the plurality of landing doors 112, one of the sensors 120 (the sensor connected to the respective landing door) produces the override signal (step 304). In examples, the override signal may be transmitted to the controller 110 via the safety chain 122.

In response to receiving the override signal, the controller 110 instructs the elevator system 100 to enter the special operating mode (step 306).

In examples, when in the special operating mode, the elevator system 100 may deploy additional safety measures at the plurality of landing doors 112 and/or in the hoistway 104 (step 308). In some examples, the elevator system 100 may deploy a safety brake, additional safety rails or balustrades, and lighting systems in the hoistway 104 or at the plurality of landing doors 112.

When the elevator system 100 is in the special operating mode, it is safe for the service personnel to enter the hoistway 104.

After completing services procedures such as maintenance or inspection, the service personnel may close the one or more landing doors of the plurality of landing doors 112 that were previously open (step 310). In some examples, the one or more landing doors may be closed by removing the key from the lock 118, by pressing a button, or by entering a code into a number pad.

In response to the one or more landing doors being closed, the sensor 120 may produce the normal output rather than the override signal (step 312). In examples, the normal output may be received by the controller 110 via the safety chain 122.

In response to receiving the normal output, the controller 110 may instruct the elevator system 100 to enter the normal mode, or to revert to the normal operating mode from the special operating mode.

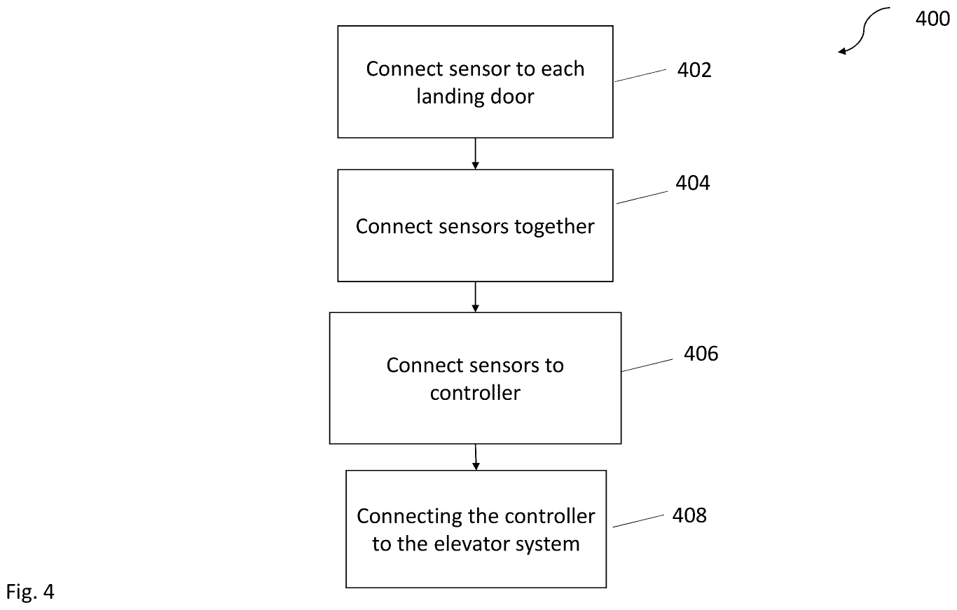

FIG. 4 depicts a method 400 of modifying an elevator system. Before modification, the elevator system comprises all of the conventional components of an elevator system, but does not comprise a safety system 105 which automatically instructs the elevator system to enter a special operating mode when service personnel attempts to access the hoistway 104. There are many such elevator systems in existence and in use in buildings which would benefit from being modified to include a safety system according to an example of the disclosure. It will be understood that a safety system 105 according to the present disclosure may be retrofitted into an existing elevator system. Further, it does not require the controller 110 to measure or monitor the location of the elevator car 102 in the hoistway 104 in order to automatically enter a special operating mode of the elevator system 100.

The method comprises connecting one or more sensors 120 to each of a plurality of landing doors 112 (step 402). In some examples, the one or more sensors 120 may be placed adjacent to each of the landing doors 112. The one or more sensors 120 are configured to produce an override signal in response to service personnel opening one or more of the plurality of landing doors 112 by a manual override.

In some examples, the method further comprises connecting the sensors 120 together, for example in series, for example by a wired connection (step 404).

The method further comprises connecting the one or more sensors 120 to a controller 110 (step 406). The controller 110 is configured to instruct the elevator system 100 to enter the special operating mode in response to receiving the override signal from the one or more sensors 120. In examples, the one or more sensors 120 and the controller 110 may be connected to form a safety chain 122. In any example, the controller 110 may be an existing controller of the elevator system 100 or may be an additional controller.

The method further comprises connecting the controller 110 to the elevator system 100 (step 408).

It will be appreciated by those skilled in the art that the disclosure has been illustrated by describing one or more examples thereof, but is not limited to these examples; many variations and modifications are possible, within the scope of the accompanying claims. For example, the elevator car may be used in a roped or ropeless elevator system, or another type of conveyance system.

What is claimed is:

1. A safety system (105) for an elevator system (100), the elevator system (100) comprising a hoistway (104), a plurality of landing doors (112a-112f) located on respective landings (106a-106f) and an elevator car (102) provided in the hoistway (104), wherein the plurality of landing doors (112a-112f) are configured to provide access to the hoistway (104),
wherein the safety system (105) comprises:
a plurality of sensors (120); and
a controller (110),
wherein each (120a) of the plurality of sensors is configured to produce an override signal when a landing door (112a) to which the sensor (120a) is connected is opened by a manual override,
wherein the controller (110) is configured to instruct the elevator system (100) to automatically enter a special operating mode when the override signal is received from one of the plurality of sensors.

2. The safety system (105) of claim 1, wherein the plurality of sensors (120) are connected to the controller (110) by a wireless connection, or
wherein the plurality of sensors (120) are connected to the controller (110) by a wired connection.

3. The safety system (105) of claim 1, wherein the plurality of sensors (120) are configured such that no override signal is produced when a landing door (112a) is opened in response to the elevator car (102) arriving at that landing (106a).

4. The safety system (105) of claim 1, wherein each (120a) of the plurality of sensors (120) is configured to be connected to a landing door (112a-112f) of a respective landing (106a-106f).

5. The safety system (105) of claim 1, wherein the plurality of sensors (120) are connected in series.

6. The safety system (105) of claim 1, wherein each of the plurality of sensors (120) comprises a switch.

7. The safety system (105) of claim 6, wherein each of the plurality of sensors (120) comprises a switch comprising an electrical contact (116) which is opened when the landing door (112) to which the sensor is connected is opened by a manual override.

8. The safety system (105) of claim 1, wherein one or more of the plurality of sensors (120) is configured to produce an override signal in response to being activated by a key, optionally wherein the key is configured to allow a landing door (112) to be opened by a manual override when inserted into a lock (118).

9. An elevator system (100), comprising:
a hoistway (104);
an elevator car (102) disposed in the hoistway (104);
a plurality of landing doors (112a-112f) each located at respective landings (106a-106f) and configured to provide access to the hoistway (104), wherein the elevator car (102) is adapted to travel to the respective landings (106a-106f); and
the safety system (105) of claim 1,
wherein each of the plurality of sensors (120) is connected to a respective one of the plurality of landing doors (112a-112f).

10. The elevator system (100) of claim 9, wherein when in the special operating mode, the elevator system (100) is configured to deploy a safety brake and/or a safety barrier, optionally an upper balustrade on the elevator car (102).

11. The safety system of claim 1, wherein the special operating mode is a service mode, and/or
wherein when in the special operating mode, the elevator car (102) is unable to move.

12. A method (300) of operating a safety system (105) for an elevator system (100),
wherein the elevator system (100) comprises: a hoistway (104), a plurality of landing doors (112a-112f) located on respective landings (106a-106f), and an elevator car (102) provided in the hoistway (104), wherein the plurality of landing doors (112a-112f) are configured to provide access to the hoistway (104),
wherein the safety system (105) comprises:
a plurality of sensors (120) each connected to a respective landing door; and
a controller (110),
the method comprising:
opening a landing door (112a) by a manual override;
in response to the opening the landing door (112a) by a manual override, the sensor connected to the landing door (112a) producing an override signal; and
in response to the controller (110) receiving the override signal, the controller (110) instructing the elevator system (100) to automatically enter a special operating mode.

13. The method (300) of claim 12, comprising:
the elevator system (100) deploying a safety brake and/or a safety barrier, optionally an upper balustrade on the elevator car (102), on automatically entering the special operating mode.

14. A computer program product for a controller (110) of a safety system (105) as claimed in claim 1, the computer program product including a non-transitory computer readable medium including instructions that, when executed by a processor, cause the controller (110) to perform operations comprising:
in response to receiving an override signal from one of the plurality of sensors (120), instructing the elevator system (100) to automatically enter a special operating mode.

15. A method (400) of modifying an elevator system (100), wherein the elevator system (100) comprises: a hoistway (104), a plurality of landing doors (112a-112f) located on respective landings (106a-106f), and an elevator car (102) provided in the hoistway (104), wherein the plurality of landing doors (112a-112f) are configured to provide access to the hoistway (104);
the method comprising:
connecting a respective sensor (120) to one or more of the plurality of landing doors (112a-112f), wherein each sensor is configured to produce an override signal in response to the landing door to which it is connected being opened by a manual override; and
connecting the sensors to a controller (110), wherein the controller (110) is configured to cause the elevator system (100) to automatically enter a special operating mode in response to receiving the override signal from one of the sensors.
